(19) United States
(12) Patent Application Publication
(10) Pub. No.: US 2026/0342997 A1
(43) Pub. Date: Oct. 29, 2026

(54) IMAGE PROCESSING APPARATUS, CONTROL METHOD THEREFOR, AND STORAGE MEDIUM FOR EFFICIENT RESTORATION OF CODING DISTORTION

(71) Applicant: CANON KABUSHIKI KAISHA, Tokyo (JP)

(72) Inventor: HAYATO OURA, Tokyo (JP)

(21) Appl. No.: 19/529,346

(22) Filed: Feb. 4, 2026

(30) Foreign Application Priority Data
Apr. 23, 2025 (JP) 2025-071425

(51) Int. Cl. H04N 19/147; H04N 19/124; H04N 19/167

(52) U.S. Cl. CPC H04N 19/147; H04N 19/124; H04N 19/167

(57) ABSTRACT

An image processing apparatus is configured to decode encoded image data and calculate the ratio of a target region in the decoded image data on which restoration processing of coding distortion is to be performed by computation of a trained model. The image processing apparatus is also configured to determine the magnitude of coding distortion in each input data obtained by dividing the decoded image data into execution units for the restoration processing, and to perform the restoration processing on the input data by computation of the trained model. The image processing apparatus is further configured to control the computational load of the trained model based on the ratio of the target region and the magnitude of the coding distortion in the input data.

### BACKGROUND

### Field of the Technology

The present disclosure relates to an image processing apparatus, a control method for the image processing apparatus, and a storage medium.

### Description of the Related Art

In recent years, technologies utilizing machine learning methods, typified by neural networks, have been applied in a variety of fields. In particular, intensive efforts have been made to develop technologies that utilize convolutional neural networks (CNNs), which receive image data or the like as input data. Technologies using CNN models are also utilized in the field of image processing. For example, a CNN model is used to restore coding distortion that occurs during data compression in encoding image data. Such technology is employed to achieve high-quality still images and moving images.

However, when an attempt is made to restore the coding distortion of image data using a single CNN model, there is a concern that the accuracy of restoration may vary depending on the degree of data compression during encoding. To address this issue, a technique has been proposed in which an appropriate CNN model is selected from among a plurality of CNN models based on a quantization parameter used during encoding, and the coding distortion restoration processing is performed using the selected CNN model (see, for example, Japanese Patent Application Laid-Open No. 2019-201255).

The locations at which coding distortion occurs differ from one piece of image data to another, and the processing time required for distortion restoration varies depending on the proportion of coding distortion present in the image data. For example, when distortion restoration processing is performed on image data in which coding distortion has occurred in a majority of regions, simply switching CNN models based on the quantization parameter used during encoding, as in the conventional technique described above, increases the computational load of the CNN models. As a result, a significant amount of time is required to complete the processing. Accordingly, there remains room for improvement in terms of increasing the processing speed of coding distortion restoration.

### SUMMARY

Embodiments described herein are directed to technology capable of achieving faster restoration processing of coding distortion.

In one embodiment, an image processing apparatus is configured to decode encoded image data. The image processing apparatus includes one or more processors and at least one memory coupled to the one or more processors and storing instructions that, when executed by the one or more processors, cause the one or more processors to perform control operations. The control operations include calculating the ratio of a target region in the decoded image data on which restoration processing of coding distortion is to be performed by computation of a trained model. The control operations further include determining the magnitude of coding distortion in each input data obtained by dividing the decoded image data into execution units for the restoration processing. The control operations further include performing the restoration processing on the input data by computation of the trained model and controlling the computational load of the trained model based on the ratio of the target region and the magnitude of the coding distortion in the input data.

Features of the present disclosure will become apparent from the following description of embodiments with reference to the attached drawings. The following description of embodiments is described by way of example.

### BRIEF DESCRIPTION OF THE DRAWINGS

FIG. 1 is a block diagram schematically illustrating the configuration of an image processing apparatus according to a first embodiment.

FIGS. 2A to 2C are diagrams for explaining restoration of coding distortion using a CNN model according to the first embodiment.

FIG. 3 is a flowchart illustrating the procedure of an image restoration control process performed by the image processing apparatus illustrated in FIG. 1.

FIG. 4 is a diagram for explaining identification of a region of interest according to a second embodiment.

FIGS. 5A to 5C are diagrams illustrating an example of the configuration of a CNN model that achieves restoration of coding distortion according to a third embodiment.

FIG. 6 is a flowchart illustrating a procedure of a parameter input process performed by an image processing apparatus according to the third embodiment.

### DESCRIPTION OF THE EMBODIMENTS

Example embodiments will be described below with reference to the accompanying drawings.

First, a description will be given of an image processing apparatus and a control method therefor according to a first embodiment.

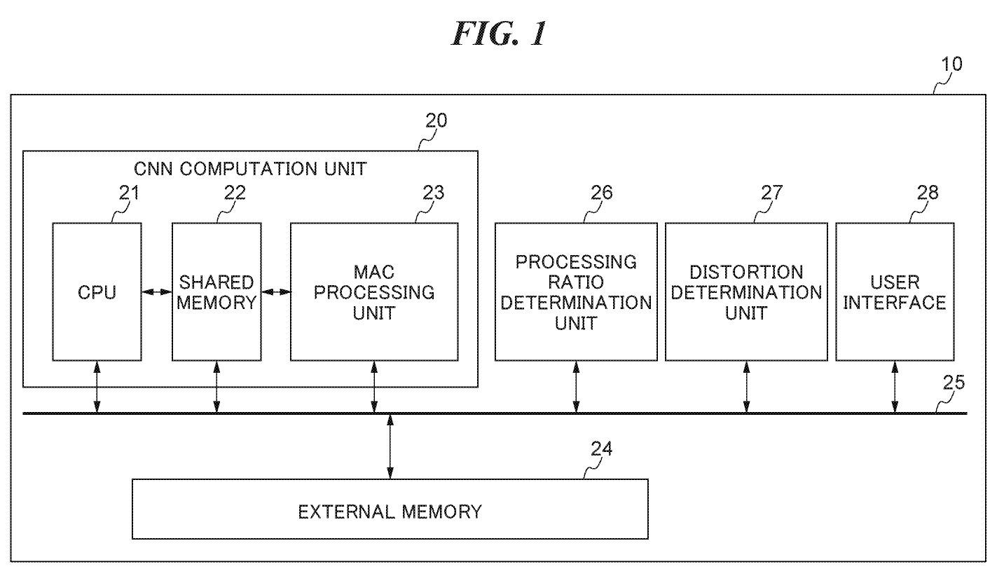

FIG. 1 is a block diagram schematically illustrating the configuration of an image processing apparatus 10 according to the first embodiment. As illustrated in FIG. 1, the image processing apparatus 10 includes a CNN computation unit 20, an external memory 24, a processing ratio determination unit 26, a distortion determination unit 27, and a user interface 28.

The CNN computation unit 20 includes a CPU 21, a shared memory 22, and a multiply-accumulate (MAC) processing unit 23. The CPU 21, the shared memory 22, the MAC processing unit 23, the external memory 24, the processing ratio determination unit 26, the distortion determination unit 27, and the user interface 28 are connected to one another via an internal bus 25. Data communication is performed among the components connected to the internal bus 25 based on a predetermined communication protocol.

The CPU 21 is a control unit that controls the operation of the image processing apparatus 10, and other processing units operate in accordance with instructions from the CPU 21. Note that the CPU 21 does not necessarily have to be included in the CNN computation unit 20.

The external memory 24 is generally a memory that is slower and has a larger capacity than the shared memory 22. The external memory 24 stores, for example, decoded image data to be processed by the CNN computation unit 20, tile data obtained by dividing the image data into tiles (execution units) for CNN processing, parameters of CNN models (trained models), and the like.

The MAC processing unit 23 serves as a central processing unit for CNN processing and repeatedly performs multiply-accumulate operations of a CNN model. The multiply-accumulate operations of the CNN model may be performed, for example, by the CPU 21, by a GPU (not illustrated) provided in the image processing apparatus 10, or by cooperation between the CPU 21 and the GPU. The shared memory 22 stores tile data serving as input data for CNN processing, computation results, parameters of a plurality of CNN models, and the like.

The processing ratio determination unit 26 calculates, using image data stored in the external memory 24 or the shared memory 22, the ratio of a region (target region) of the image data on which CNN processing is to be performed (hereinafter referred to as “processing ratio information”). The processing ratio determination unit 26 may be included in the CNN computation unit 20. In addition, processing performed by the processing ratio determination unit 26 may be performed by the CPU 21 or the MAC processing unit 23.

The distortion determination unit 27 acquires distortion information indicating the magnitude of coding distortion included in tile data stored in the external memory 24 or the shared memory 22. The distortion determination unit 27 may be included in the CNN computation unit 20. In addition, processing performed by the distortion determination unit 27 may be performed by the CPU 21 or the MAC processing unit 23.

The user interface 28 receives various setting values specified by a user of the image processing apparatus 10. The setting values specified by the user are stored in the external memory 24 or the shared memory 22 and are read out by the CPU 21 or the like.

Next, the generation of distortion information by the distortion determination unit 27 will be described.

In the present embodiment, the distortion determination unit 27 acquires distortion information from a quantization parameter for each tile data. Specifically, the distortion determination unit 27 acquires one or more quantization parameters in the tile data, calculates the maximum value, average value, or variance value of the acquired quantization parameters, and generates distortion information indicating the magnitude of coding distortion based on the calculated value. The distortion determination unit 27 performs this processing for each tile data. For example, when the maximum value of the quantization parameters in the tile data is equal to or greater than a threshold, the coding distortion is determined to be large, whereas when the maximum value is less than the threshold, the coding distortion is determined to be small. Likewise, when the average value is used, whether the coding distortion is large or small is determined based on the average value, as in the case where the maximum value is used. When the variance value is used, the larger the variance value is, the more the region contains a mixture of large and small quantization parameters; therefore, the coding distortion is determined to be large.

Alternatively, the maximum value, average value, and variance value of the quantization parameters in the tile data may be used in combination. For example, even if the average value of the quantization parameters is less than a threshold, when the variance value is large, the region contains a mixture of large and small quantization parameters, and thus the coding distortion is determined to be large. Although the magnitude of the coding distortion has been described as being determined based on the maximum value, average value, or variance value of the quantization parameters, this is merely an example, and the determination method is not limited thereto.

Next, calculation of processing ratio information by the processing ratio determination unit 26 will be described.

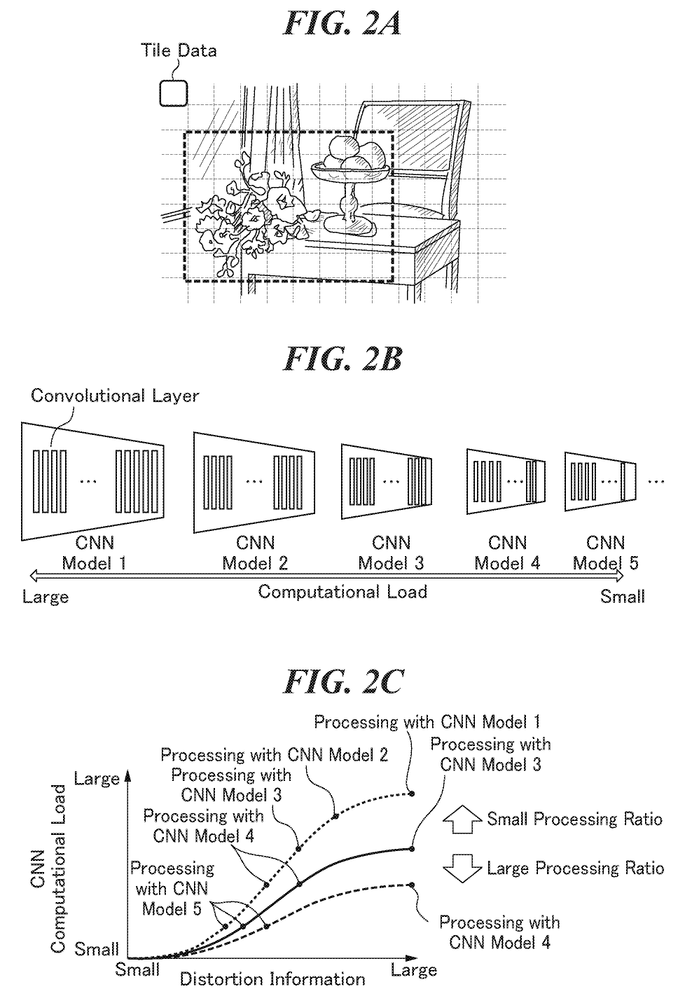

FIG. 2A is a diagram illustrating an example of decoded image data that includes coding distortion. In the present embodiment, CNN processing refers to processing for restoring coding distortion. In FIG. 2A, regions partitioned by grid-like dashed lines represent tile data. A region surrounded by a thick dashed line represents a region that is not to be subjected to CNN processing. Note that the region not to be subjected to CNN processing illustrated in FIG. 2A is merely an example and is not intended to be limiting.

As one example of a method for defining a region that is not to be subjected to CNN processing, a method using distortion information generated by the distortion determination unit 27 may be employed. In this method, whether a region is to be excluded from CNN processing is defined based on the distortion information corresponding to each piece of tile data cut out from the image data. For example, if the distortion information is less than a predetermined value, the coding distortion is small and the necessity of performing distortion restoration processing is extremely low; therefore, the region of the tile data corresponding to such distortion information is defined as a region that is not to be subjected to CNN processing. The processing ratio determination unit 26 calculates, as processing ratio information, the ratio of the area of regions other than those defined not to be subjected to CNN processing to the total area of the image data.

Next, an image restoration control process performed by the image processing apparatus 10 will be described.

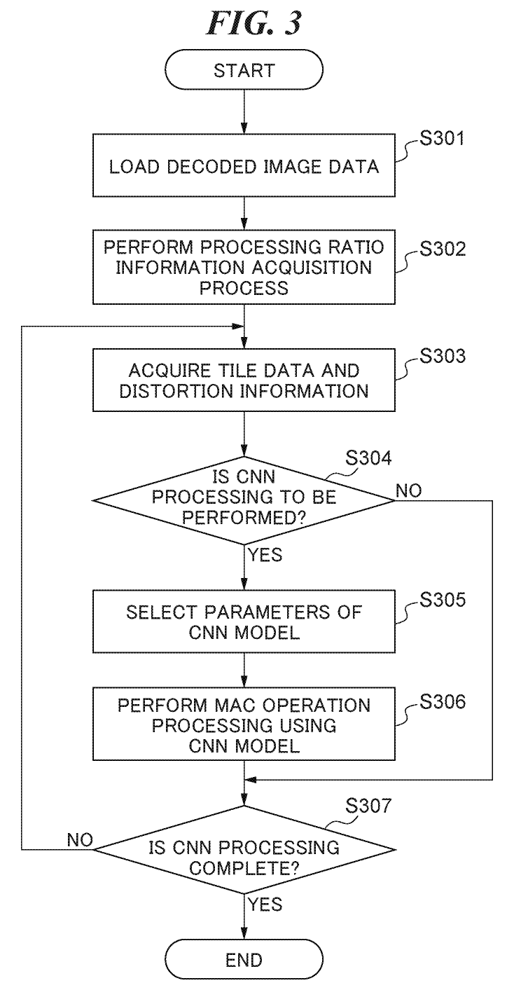

FIG. 3 is a flowchart illustrating the procedure of the image restoration control process performed by the image processing apparatus 10 illustrated in FIG. 1. The image restoration control process is implemented by the CPU 21 reading and executing instructions of a program stored in the external memory 24 or the shared memory 22. Note that the processing performed by the processing ratio determination unit 26 or the distortion determination unit 27 need not necessarily be performed by these units and may alternatively be performed by the MAC processing unit 23.

In FIG. 3, first, in step S301, the CPU 21 loads the decoded image data stored in the external memory 24 into the shared memory 22.

Next, in step S302, the CPU 21 performs a processing ratio information acquisition process. Specifically, the CPU 21 first segments the image data loaded into the shared memory 22 into tiles for CNN processing to obtain tile data. The CPU 21 inputs the obtained tile data to the distortion determination unit 27. In this manner, the CPU 21 divides the image data loaded into the shared memory 22 into tile data and inputs the tile data to the distortion determination unit 27. The distortion determination unit 27 calculates the maximum value, average value, or variance value of the quantization parameters in the input tile data. The distortion determination unit 27 then generates distortion information indicating the magnitude of coding distortion based on the calculated value. The distortion determination unit 27 generates distortion information for each of all the tile data obtained from the CPU 21. The generated distortion information is stored in the shared memory 22. The CPU 21 then inputs all the distortion information stored in the shared memory 22 to the processing ratio determination unit 26. The processing ratio determination unit 26 counts the number of pieces of distortion information having values equal to or greater than a predetermined value among all the input distortion information, and obtains, based on the counted number, processing ratio information indicating the ratio of regions to be subjected to CNN processing relative to the entire image data. The processing ratio information is stored in the shared memory 22.

Next, in step S303, the CPU 21 acquires one piece of tile data from the image data that has been loaded into the shared memory 22. The CPU 21 also acquires distortion information corresponding to the tile data from the shared memory 22.

Next, in step S304, the CPU 21 determines whether to perform CNN processing on the tile data acquired in step S303 based on the distortion information acquired in step S303. For example, when the distortion information acquired in step S303 is less than a predetermined value, it is determined that CNN processing is not to be performed on the tile data acquired in step S303. In this case, the process proceeds to step S307 (described later).

On the other hand, when the distortion information acquired in step S303 is equal to or greater than the predetermined value, it is determined that CNN processing is to be performed on the tile data acquired in step S303. In this case, the process proceeds to step S305.

In step S305, the CPU 21 selects parameters of a CNN model to be used in step S306 (described later), based on the distortion information acquired in step S303 and the processing ratio information acquired in step S302. In the present embodiment, parameters of a plurality of CNN models with different computational loads (computational complexities) for performing restoration of coding distortion are stored in the shared memory 22. As one example, in the present embodiment, parameters of CNN model 1, CNN model 2, CNN model 3, CNN model 4, and CNN model 5 illustrated in FIG. 2B are stored in the shared memory 22. It is assumed that CNN model 1, CNN model 2, CNN model 3, CNN model 4, and CNN model 5 have increasing computational loads in this order and can restore coding distortion with correspondingly higher accuracy. A CNN model with a larger computational load has more intermediate layers and/or more filters per intermediate layer. The CNN models may be obtained in advance by training with different levels of computational load, or they may alternatively be obtained by applying pruning with different strengths to a single trained CNN model, where pruning is a process of removing parameters that have relatively small influence on the output.

In the present embodiment, as indicated by the solid line in FIG. 2C, the smaller the distortion information of the tile data to be input to the CNN model, the smaller the computational load of the CNN model whose parameters are selected, thereby reducing the computational load of the CNN model used. Conversely, the larger the distortion information of the tile data to be input to the CNN model, the larger the computational load of the CNN model whose parameters are selected, thereby increasing the computational load of the CNN model used. In the graph illustrated in FIG. 2C, the solid line indicates, for example, the relationship between the distortion information and the computational load of the CNN model when the processing ratio information is 50 %.

For example, when the processing ratio information is greater than 50 %, the number of tiles (tile data) to be processed becomes larger than when the processing ratio information is 50 %, and accordingly it takes a longer time to complete the restoration processing of coding distortion. In such a case, according to the present embodiment, as indicated by the dashed line in FIG. 2C, when the distortion information is the same, the parameters of a CNN model having a smaller computational load than in the case where the processing ratio information is 50 % are selected, thereby reducing the computational load of the CNN model used. In this manner, in the present embodiment, it is possible to realize faster restoration of coding distortion.

On the other hand, when the processing ratio information is smaller than 50 %, the number of tiles (tile data) to be processed becomes smaller than when the processing ratio information is 50 %, and accordingly the restoration processing of coding distortion can be completed within a shorter time. In such a case, according to the present embodiment, as indicated by the dotted line in FIG. 2C, when the distortion information is the same, the parameters of a CNN model having a larger computational load than in the case where the processing ratio information is 50 % are selected, thereby increasing the computational load of the CNN model used. By selecting the parameters of a CNN model having a larger computational load than in the case where the processing ratio information is 50 %, the coding distortion can be restored with higher accuracy. However, from the viewpoint of speeding up the restoration processing of coding distortion, the parameters of a CNN model may be selected such that the time required to complete the restoration of coding distortion is substantially the same as or shorter than that in the case where the processing ratio information is 50 %. Thus, in the present embodiment, it is possible to restore coding distortion with higher accuracy while maintaining the time required to complete the restoration processing of coding distortion substantially the same as or shorter than that in the case where the processing ratio information is 50 %. The selected parameters of the CNN model, after being loaded into the shared memory 22 by the CPU 21, are input to the MAC processing unit 23. Note that when the same CNN model as the one used immediately before is to be used, the process in step S305 may be omitted.

Next, in step S306, the CPU 21 performs multiply–accumulate (MAC) operation processing using the CNN model. Specifically, the CPU 21 inputs the tile data acquired in step S303 to the MAC processing unit 23. The MAC processing unit 23 uses this tile data as input and performs multiply-accumulate operations using the parameters of the CNN model selected in step S305. The result of the multiply-accumulate operations is stored in the shared memory 22.

Next, in step S307, the CPU 21 determines whether the CNN processing has been completed for all regions of the image data. If it is determined that the CNN processing has not been completed for any region of the image data, the process returns to step S303. On the other hand, if it is determined that the CNN processing has been completed for all regions of the image data, the process ends.

According to the embodiment described above, the computational load of the CNN model is controlled based on the processing ratio information and the distortion information. As a result, the total computational load of the CNN model can be reduced in accordance with the degree of coding distortion occurring in the image data, thereby enabling faster restoration processing of coding distortion.

According to the embodiment described above, the processing ratio information is calculated based on the quantization parameters used during encoding of the decoded image data. Therefore, faster restoration processing of coding distortion can be achieved in a configuration in which the quantization parameters used during encoding of the decoded image data can be obtained.

In addition, according to the embodiment described above, the magnitude of coding distortion in tile data is determined based on the distortion information calculated from the quantization parameters corresponding to the tile data. Accordingly, faster restoration processing of coding distortion can be achieved in a configuration in which the quantization parameters corresponding to the tile data can be obtained.

Furthermore, according to the embodiment described above, among the tile data cut out from the decoded image data, CNN processing for restoring coding distortion is performed only on tile data determined to have coding distortion with a magnitude equal to or greater than a predetermined value. As a result, it is possible to limit the processing target to only the tile data that requires restoration of coding distortion, thereby suppressing unnecessary computation in the restoration processing of coding distortion.

Furthermore, according to the embodiment described above, the parameters of a CNN model having a larger computational load are selected as the magnitude of coding distortion increases, whereas the parameters of a CNN model having a smaller computational load are selected as the magnitude of coding distortion decreases. As a result, the restoration processing of coding distortion can be performed by using a CNN model having a computational load appropriate to the magnitude of the coding distortion.

Furthermore, according to the embodiment described above, the parameters of a CNN model having a smaller computational load are selected as the processing ratio information increases, whereas the parameters of a CNN model having a larger computational load are selected as the processing ratio information decreases. As a result, the restoration processing of coding distortion can be performed by using a CNN model having a computational load appropriate to the number of tiles (tile data) to be processed.

Next, a description will be given of an image processing apparatus and a control method therefor according to a second embodiment.

The second embodiment is basically the same as the first embodiment described above in terms of configuration and operation, except that it differs from the first embodiment in the method of calculating the processing ratio information and the method of generating the distortion information. Accordingly, the following description will mainly focus on the differences in configuration and operation, and the same or duplicative explanations will not be repeated.

The calculation of the processing ratio information according to the second embodiment will now be described.

In the second embodiment, information other than a quantization parameter is used for the calculation of the processing ratio information, instead of distortion information generated based on the quantization parameter. Examples of such information other than a quantization parameter include region-of-interest information in the image data. The region-of-interest information refers to information indicating whether a region in the image data is regarded as a subject of interest. Examples of methods for acquiring the region-of-interest information include a method of acquiring a region of interest defined at the time of encoding, a method using a CNN, and a method using gaze point information obtained when the image data is displayed. In a typical method for acquiring a region of interest using a CNN, objects in the image data are segmented by a segmentation technique such as semantic segmentation or instance segmentation, and a degree of interest is calculated for each object. Note that that the segmentation techniques are not limited to those described above. In addition, the gaze point information refers to information indicating a region at which a viewer gazes when a still image is extracted from a moving image to generate image data, for example.

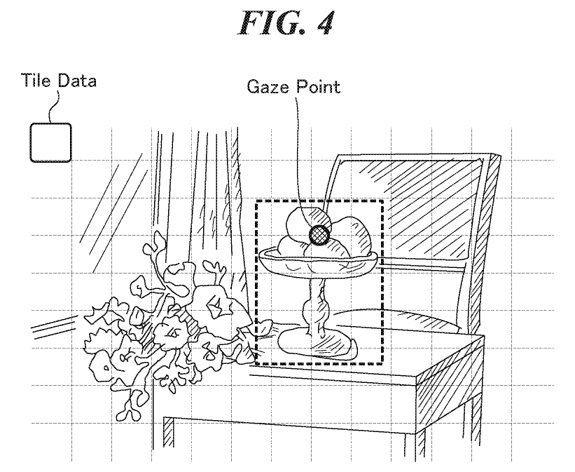

Furthermore, as illustrated in FIG. 4, it is also conceivable to determine the region of interest by combining gaze point information and a segmentation technique. In FIG. 4, a region indicated within the thick dashed frame that includes an area related to the gaze point is determined as the region of interest. Note that the gaze point may be specified not only as a single point but also as a plurality of points.

In general, a region of interest is a region to which a viewer tends to direct their gaze and in which degradation of image quality tends to be noticeable. Therefore, during encoding, a larger number of bits tends to be allocated to such a region relative to the entire image, and such a region can be regarded as having a smaller magnitude of coding distortion. Accordingly, since the influence of coding distortion is small, the region of interest can be regarded as having a low necessity for restoration of coding distortion, and is thus determined as a region that is not to be subjected to CNN processing. In other words, in the second embodiment, a region of non-interest, which is a region other than the region of interest in the image data, serves as the region to be subjected to CNN processing.

Next, the generation of distortion information in the second embodiment will be described.

In the second embodiment, the distortion determination unit 27 generates distortion information for each tile of the image data by performing an inference process using a CNN model that generates distortion information, based on quantization parameters. As an example of a method for training the CNN model used to generate distortion information, training is performed in advance such that the inference result of the CNN model used in the distortion determination unit 27 becomes similar to the distortion information generated in the first embodiment described above. As another example of a training method, when a CNN model is trained to express the inference result of the magnitude of distortion information in ten levels, the training is performed such that the larger the coding distortion, the larger the value output among the ten levels. Note that the training method for the CNN model that generates the distortion information is not limited to those described above, and the CNN model may be trained in advance using a method other than the above methods.

In addition, when the tile data is included in the above-described region of interest and can be determined as having no need for CNN processing to restore coding distortion, the distortion information for the tile data may be output as a small value without newly acquiring the distortion information from the tile data.

Next, an image restoration control process according to the second embodiment will be described. Note that the image restoration control process of the second embodiment is basically the same as the image restoration control process described above with reference to FIG. 3, except that the process in steps S302 and S303 differs from that in the image restoration control process illustrated in FIG. 3. Therefore, the following description will focus on the differences from the image restoration control process illustrated in FIG. 3 described above.

In step S302, the CPU 21 performs a processing ratio information acquisition process. Specifically, the CPU 21 inputs the image data to the processing ratio determination unit 26. The processing ratio determination unit 26 performs, for example, an inference process using a CNN model that calculates a degree of interest for a subject region in the input image data. The processing ratio determination unit 26 identifies the subject region (region of a main subject) as a region of interest when the calculated degree of interest is equal to or greater than a threshold. The processing ratio determination unit 26 identifies a region other than the region of interest as a region of non-interest. The processing ratio determination unit 26 calculates the ratio of the region of non-interest to the entire image data, with the region of non-interest corresponding to a region to be subjected to CNN processing, thereby obtaining the processing ratio information. Note that, when the region of interest is known at the time of encoding or when gaze point information can be acquired, the CPU 21 inputs such information to the processing ratio determination unit 26, and the processing ratio determination unit 26 calculates the processing ratio information based on the input information. The processing ratio information is stored in the shared memory 22.

Next, in step S303, the CPU 21 acquires tile data from the image data that has been loaded into the shared memory 22 and inputs the tile data to the distortion determination unit 27. The distortion determination unit 27 performs an inference process using a CNN model that calculates distortion information for the input tile data, thereby generating distortion information. The generated distortion information is stored in the shared memory 22. Thereafter, the process proceeds to step S304, and steps S305 to S307 are performed.

According to the second embodiment described above, a region of non-interest is identified in the decoded image data, and the processing ratio information is calculated based on the area of the region of non-interest. As a result, faster restoration processing of coding distortion can be achieved even in a configuration in which the quantization parameters used during encoding of the decoded image data cannot be obtained.

In addition, according to the second embodiment described above, a region other than the main subject region in the decoded image data is identified as a region of non-interest. This makes it possible to perform restoration processing of coding distortion on a region whose degree of interest is equal to or less than a threshold.

Furthermore, according to the second embodiment described above, regions other than the region specified based on gaze point information are identified as regions of non-interest. Accordingly, it is possible to perform restoration processing of coding distortion on regions other than the region that the user who viewed the image data was gazing at.

Furthermore, according to the second embodiment described above, distortion information is generated through an inference process using a CNN model that generates distortion information. This enables the generation of distortion information necessary for achieving faster restoration processing of coding distortion in a configuration in which the quantization parameters used during encoding of the decoded image data cannot be obtained.

Next, a description will be given of an image processing apparatus and a control method therefor according to a third embodiment.

The third embodiment is basically the same as the first and second embodiments described above in terms of configuration and operation, except that it differs from the first and second embodiments in the configuration of the CNN model that performs restoration of coding distortion. Accordingly, the following description will mainly focus on the differences in configuration and operation, and the same or duplicative explanations will not be repeated.

In the third embodiment, a portion of intermediate layers in CNN models for restoring coding distortion is shared as common parameters. Further, additional parameters from the input layer to the shared intermediate layers, as well as additional parameters from the shared intermediate layers to the output layer, are controlled to prepare a plurality of CNN models having different computational loads.

The configuration of the CNN model that performs restoration of coding distortion according to the third embodiment will now be described.

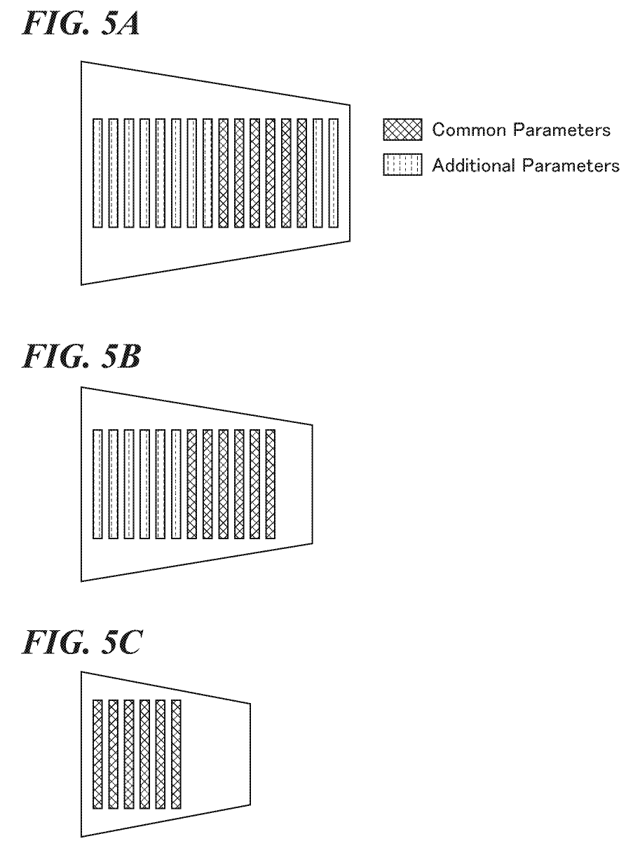

FIG. 5A illustrates a CNN model composed of 16 layers in total, FIG. 5B illustrates a CNN model composed of 12 layers in total, and FIG. 5C illustrates a CNN model composed of 6 layers in total. More specifically, of the total 16 layers illustrated in FIG. 5A, 6 layers serve as common parameters, and 10 layers serve as additional parameters. Of the total 12 layers illustrated in FIG. 5B, 6 layers serve as common parameters and 6 layers serve as additional parameters. In FIG. 5C, all 6 layers serve as common parameters. Note that the configurations of the CNN models illustrated in FIGS. 5A to 5C are provided by way of example only and not of limitation. Among the parameters of the CNN models, the common parameters are trained in common across the respective CNN models when training is performed to achieve restoration of coding distortion. On the other hand, the additional parameters are switched among the respective CNN models and are individually trained. In this case, the CNN models each select the number of layers of the additional parameters from the input layer to a predetermined intermediate layer and from the predetermined intermediate layer to the output layer. As illustrated in FIGS. 5A to 5C, among the plurality of CNN models that perform restoration of coding distortion, a CNN model having a smaller computational load is configured to have fewer layers of additional parameters, thereby reducing the overall computational load of the CNN model including the additional parameters. The additional parameters do not need to have the same number of layers on the input layer side and the output layer side in each CNN model. In addition, when a CNN model having a larger computational load is compared with a CNN model having a smaller computational load, the difference in computational load corresponds to the difference in the number of layers of additional parameters. This relationship is illustrated by the pairs of CNN models in FIGS. 5A and 5B, and in 5B and 5C.

Next, an image restoration control process according to the third embodiment will be described. Note that the image restoration control process of the third embodiment is basically the same as the image restoration control process described above with reference to FIG. 3, except that the process in step S305 differs from that in the image restoration control process illustrated in FIG. 3. Therefore, the following description will focus on the differences from the image restoration control process illustrated in FIG. 3 described above.

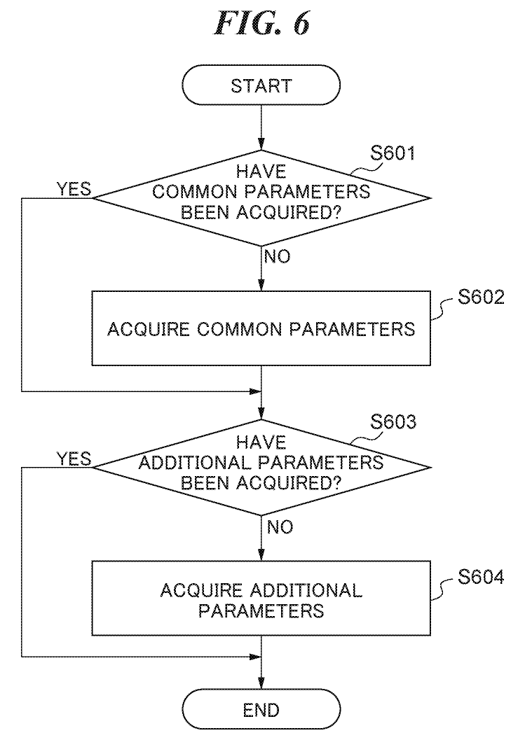

In step S305, the CPU 21 selects parameters of a CNN model to be used for restoration processing of coding distortion based on the distortion information acquired in step S303 and the processing ratio information acquired in step S302. The CPU 21 then performs a parameter input process illustrated in FIG. 6.

FIG. 6 is a flowchart illustrating a procedure of the parameter input process performed by the image processing apparatus 10 according to the third embodiment.

With reference to FIG. 6, in step S601, the CPU 21 first determines whether the common parameters of the selected CNN model have already been input to the MAC processing unit 23. If it is determined that the common parameters of the selected CNN model have already been input to the MAC processing unit 23, the process proceeds to step S603 (described later). If it is determined that the common parameters of the selected CNN model have not been input to the MAC processing unit 23, the process proceeds to step S602.

In step S602, the CPU 21 loads the common parameters of the selected CNN model into the shared memory 22 and then inputs the common parameters to the MAC processing unit 23.

Next, in step S603, the CPU 21 determines whether the additional parameters of the selected CNN model have already been input to the MAC processing unit 23. If it is determined that the additional parameters of the selected CNN model have already been input to the MAC processing unit 23, this process ends, and the image restoration control process in the third embodiment proceeds to step S306.

If it is determined that the additional parameters of the selected CNN model have not been input to the MAC processing unit 23, the process proceeds to step S604.

In step S604, the CPU 21 loads the additional parameters of the selected CNN model into the shared memory 22 and then inputs the additional parameters to the MAC processing unit 23. Note that if parameters other than the additional parameters of the selected CNN model have been loaded into the shared memory 22, the CPU 21 deletes those parameters from the shared memory 22. Thereafter, the CPU 21 loads the additional parameters of the selected CNN model into the shared memory 22 and inputs the additional parameters to the MAC processing unit 23. Upon completion of step S604, this process ends, and the image restoration control process in the third embodiment proceeds to step S306.

Note that when the same CNN model as the one used immediately before is to be used for restoring coding distortion, the parameters have already been input to the MAC processing unit 23. Therefore, it is not necessary to perform the parameter input process shown illustrated in FIG. 6.

According to the third embodiment described above, as the configuration of a plurality of CNN models that perform restoration of coding distortion, some or all of the layers of the respective CNN models are used as common parameters. In addition, the plurality of CNN models are prepared by switching additional parameters from the input layer to a predetermined intermediate layer, or from the predetermined intermediate layer to the output layer. By configuring the CNN models to have common portions, the amount of parameter transfer can be reduced upon switching among the CNN models that perform restoration of coding distortion. As a result, it is possible to reduce the amount of data transfer upon switching the parameters of the CNN models in the image restoration control process described above.

According to the embodiments described above, it is possible to achieve faster restoration processing of coding distortion.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)^{TM}), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-071425, filed Apr. 23, 2025, which is hereby incorporated by reference herein in its entirety.

What is claimed is:

1. An image processing apparatus configured to decode encoded image data, comprising:
one or more processors; and
at least one memory coupled to the one or more processors and storing instructions that, when executed by the one or more processors, cause the one or more processors to perform operations comprising:
calculating a ratio of a target region in the decoded image data on which restoration processing of coding distortion is to be performed by computation of a trained model;
determining a magnitude of coding distortion in each input data obtained by dividing the decoded image data into execution units for the restoration processing; and
performing the restoration processing on the input data by computation of the trained model,
wherein a computational load of the trained model is controlled based on the ratio of the target region and the magnitude of the coding distortion in the input data.

2. The image processing apparatus according to claim 1, wherein the ratio of the target region is calculated based on quantization parameters used during encoding of the decoded image data.

3. The image processing apparatus according to claim 1, wherein
the operations further comprise identifying a region of non-interest in the decoded image data, and
the ratio of the target region is calculated based on an area of the region of non-interest.

4. The image processing apparatus according to claim 3, wherein a region other than a region of a main subject in the decoded image data is identified as the region of non-interest.

5. The image processing apparatus according to claim 3, wherein a region other than a region specified based on gaze point information indicating a region gazed at by a user viewing the decoded image data is identified as the region of non-interest.

6. The image processing apparatus according to claim 1, wherein the magnitude of the coding distortion in the input data is determined using a trained model that has been trained in advance.

7. The image processing apparatus according to claim 1, wherein the magnitude of the coding distortion in the input data is determined based on distortion information calculated from quantization parameters corresponding to the input data.

8. The image processing apparatus according to claim 7, wherein the distortion information is a maximum value, an average value, or a variance value of the quantization parameters.

9. The image processing apparatus according to claim 1, wherein, among input data obtained from the decoded image data, the restoration processing is performed only on input data determined to have a magnitude of coding distortion equal to or greater than a predetermined value.

10. The image processing apparatus according to claim 1, wherein the computational load of the trained model is increased as the magnitude of the coding distortion increases, and the computational load of the trained model is decreased as the magnitude of the coding distortion decreases.

11. The image processing apparatus according to claim 1, wherein the computational load of the trained model is decreased as the ratio of the target region increases, and the computational load of the trained model is increased as the ratio of the target region decreases.

12. A control method for an image processing apparatus configured to decode encoded image data, the control method comprising:
calculating a ratio of a target region in the decoded image data on which restoration processing of coding distortion is to be performed by computation of a trained model;
determining a magnitude of coding distortion in each input data obtained by dividing the decoded image data into execution units for the restoration processing; and
performing the restoration processing on the input data by computation of the trained model,
wherein a computational load of the trained model is controlled based on the ratio of the target region and the magnitude of the coding distortion in the input data.

13. A non-transitory computer-readable storage medium comprising computer-executable instructions stored thereon that, when executed by a computer, cause the computer to implement a control method for an image processing apparatus configured to decode encoded image data, the control method comprising:
calculating a ratio of a target region in the decoded image data on which restoration processing of coding distortion is to be performed by computation of a trained model;
determining a magnitude of coding distortion in each input data obtained by dividing the decoded image data into execution units for the restoration processing; and
performing the restoration processing on the input data by computation of the trained model,
wherein a computational load of the trained model is controlled based on the ratio of the target region and the magnitude of the coding distortion in the input data.
